(19) United States
(12) Patent Application Publication
(10) Pub. No.: US 2014/0029806 A1
(43) Pub. Date: Jan. 30, 2014

(54) OBJECT SEARCHING APPARATUS, OBJECT SEARCHING METHOD AND COMPUTER-READABLE RECORDING MEDIUM

(71) Applicant: CASIO COMPUTER CO., LTD., Tokyo (JP)

(72) Inventors: Michihiro NIHEI, Tokyo (JP); Kazuhisa MATSUNAGA, Tokyo (JP); Masayuki HIROHAMA, Tokyo (JP); Kouichi NAKAGOME, Tokorozawa-shi (JP)

(21) Appl. No.: 13/926,835

(22) Filed: Jun. 25, 2013

(30) Foreign Application Priority Data
Jul. 24, 2012 (JP) 2012-163860

(51) Int. Cl. G06T 7/00

(52) U.S. Cl. CPC G06T 7/004
USPC 382/106

(57) ABSTRACT

In an object searching apparatus for searching through a database of objects, an image pickup unit repeatedly shoots a subject with the optical axis moved to obtain plural pieces of image data. A distance from the image pickup unit to the subject is calculated based on the plural pieces of image data, and a main object of the subject is clipped from the obtained image data. A calculating unit calculates a real size of the main object of the subject based on a size of the clipped main object on the image data, the calculated distance from the image pickup unit to the subject and a focal length of the image pickup unit. A searching unit accesses the database to search for a sort of the main object of the subject, using the calculated real size of the main object.

### CROSS-REFERENCE TO RELATED APPLICATION

The present application is based upon and claims the benefit of priority from the prior Japanese Patent Application No. 2012-163860, filed Jul. 24, 2012, the entire contents of which are incorporated herein by reference.

### BACKGROUND OF THE INVENTION

1. Field of the Invention

The present invention relates to an object searching apparatus, an object searching method, and a computer readable recording medium, which obtain pickup image data and clip a main object area from an image represented by the pickup image data, searching for a sort of the main object.

2. Description of the Related Art

When traipsing the fields, we often see a flower by the roadside and want to know the name of such flower. Then, we shoot the flower with a digital camera and obtain a digital image of the flower. Using Clustering, an image of an object or the flower is extracted from the digital image of the flower, and a single or plural characterizing amounts or characterizing information of the flower is obtained from the extracted image of the flower. Then, the characterizing amounts of the flower obtained in the above mentioned manner and characterizing amounts of various flowers previously registered in database are statistically analyzed to discriminate the sort of the flower, which technical method has been proposed, for example, by Japanese Unexamined Patent Publication No. 2002-203242.

A conventional technique is known, which uses Graph cuts to separate an image including a main object such as a flower into a main object area and a background area, thereby clipping the main object area from the original image. For example, Graph cuts was disclosed by Y. Boykov and G. Funka-Lea: “Interactive Graph Cuts for Optimal Boundary & Region Segmentation of Objects in N-D Images”, Proceedings of “Internation Conference on Computer Vision”, Vancouver, Canada, vol. I, p. 105-112, July 2001, and also by Japanese Unexamined Patent Publication No. 2011-35636. When clipping the main object area from the image, since there can be an indistinct portion in the boundary between the main object area and the background area due to the relationship between them, it is required to perform the best area separation. The conventional technique treated the area separation as an energy minimizing problem and proposed the energy minimizing method. In the conventional technique, a graph is produced, which complies with the area separation, and the minimizing cuts of the graph are obtained, thereby minimizing an energy function. Using the maximum flow algorithm, the minimizing cuts allow an effective area separating calculation.

However, in a process of specifying the main object such as a flower, whose discriminating feature is in its size, when operation of searching for the specific flower through plural flowers is performed only based on the characteristic of the image, if plural pieces of data have similar characteristic, it is almost impossible for the conventional technique to automatically discriminate and specify the difference between the plural pieces of data, even though the main object area is clipped correctly.

### SUMMARY OF THE INVENTION

According to one aspect of the invention, there is provided an object searching apparatus, in which accuracy in searching for a main object can be enhanced.

According to still other aspect of the invention, there is provided an object searching apparatus for searching through a database of objects, which apparatus comprises an image pickup unit for obtaining plural pieces of image data with an optical axis moved relatively to a subject to be shot, a distance calculating unit for calculating a distance from the image pickup unit to the subject based on the plural pieces of image data obtained by the image pickup unit, a clipping unit for clipping a main object of the subject from the image data, wherein the subject at least consists of the main object and a background, a real-size calculating unit for calculating a real size of the main object of the subject, using a size of the clipped main object on the image data, the distance calculated by the distance calculating unit and a focal length of the image pickup unit, and a searching unit for accessing the database of objects to search for a sort of the main object of the subject, using the real size of the main object calculated by the real-size calculating unit.

In an object searching apparatus according to the invention, an image pickup unit obtains plural pieces of image data with the optical axis moved relatively to a subject to be shot, and a real size of a main object of the subject is calculated from the obtained image data, and a searching unit accesses a database of objects to search for a sort of the main object, using the calculated real size of the main object, thereby enhancing searching accuracy.

### BRIEF DESCRIPTION OF THE DRAWINGS

FIG. 1 is a block diagram showing an example of a hardware configuration of an object searching apparatus according to the embodiment of the invention.

FIG. 2 is a block diagram showing functions of the object searching apparatus realized by a digital camera shown in FIG. 1.

FIG. 3 is a flow chart of an object searching process performed in the present embodiment of the invention.

FIG. 4 is a view for explaining a depth calculating process performed in the present embodiment of the invention.

FIG. 5 is a view for explaining a real size calculating process performed in the present embodiment of the invention.

FIG. 6 is a flow chart of Graph cuts at step S304 in the flow chart of FIG. 3.

FIG. 7 is a view for explaining a weighted and directed graph.

FIG. 8(a) is a view for explaining a histogram θ (c, 0).

FIG. 8(b) is a view for explaining a histogram θ (c, 1).

FIG. 9 is a characteristic graph of hᵤᵥ (Xᵤ, Xᵥ).

FIG. 10 is a view schematically showing a relationship between a graph including t-link and n-link and an area label vector X and Graph cuts.

FIG. 11 is a flow chart of an area separating process at step S602 in the flow chart of FIG. 6.

### DETAILED DESCRIPTION OF THE PREFERRED EMBODIMENTS

Now, the preferred embodiments of the invention will be described with reference to the accompanying drawings in detail.

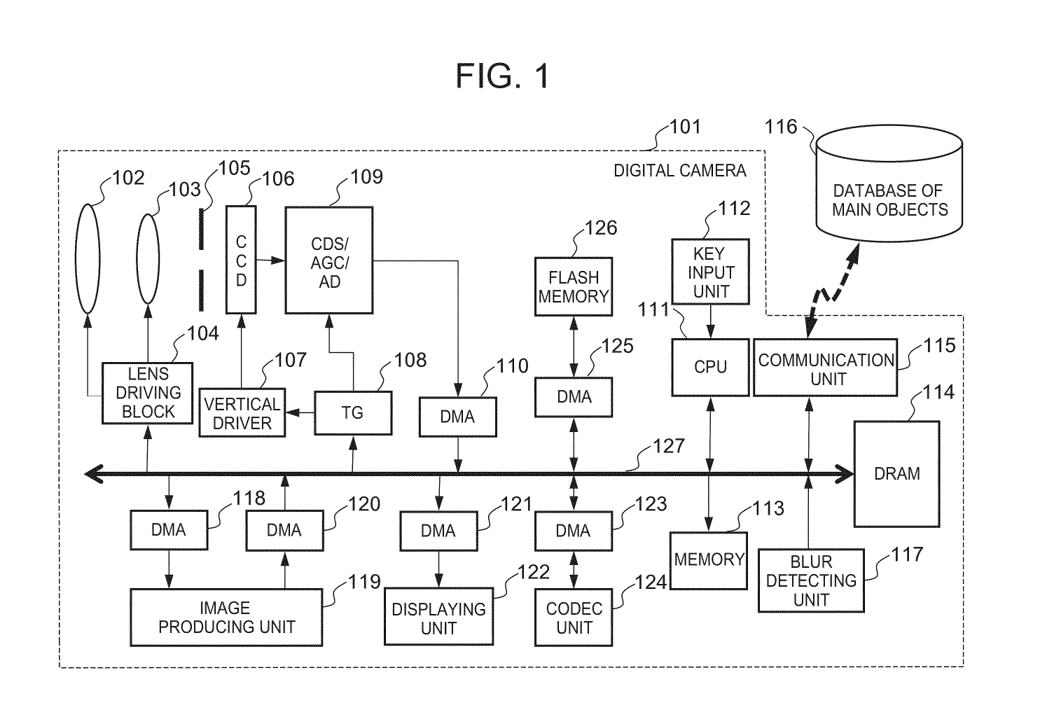

FIG. 1 is a block diagram showing an example of a hardware configuration of a digital camera 101, which realizes an object searching apparatus according to the embodiment of the invention.

The digital camera 101 comprises an image pickup lens 102, a correcting lens 103, a lens driving block 104, a diaphragm/shutter mechanism 105, CCD 106, a vertical driver 107, TG (timing generator) 108, a unit circuit 109, DMA controller (Hereinafter, “DMA”) 110, CPU (Central Processing Unit) 111, a key input unit 112, a memory 113, DRAM (Dynamic Random Access Memory) 114, a communication unit 115, a blur detecting unit (or camera-shake detecting unit) 117, DMA (Direct Memory Access) 118, an image producing unit 119, DMA 120, DMA 121, a displaying unit 122, DMA 123, a coder/decoder unit (Hereinafter, the “CODEC unit”) 124, DMA 125, a flash memory 126, and a bus 127.

The digital camera 101 is provided with a built-in or an external database 116 of the main object.

In the case where the database 116 of the main object is not mounted on the digital camera 101, the database 116 of the main object is implemented in a sever computer connected thereto through the Internet, and CPU 111 of the digital camera 101 uses the communication unit 115 to access the database 116 of the main object implemented in the server computer through the Internet.

In the case where the database 116 of the main object is mounted on the digital camera 101, for instance, the database 116 of the main object is implemented in DRAM 114, and CPU 111 accesses the database 116 of the main object implemented in DRAM 114.

The image pickup lens 102 consists of plural lenses (lens group), including a focus lens and a zoom lens.

The lens driving block 104 has a driving circuit (not shown), and the driving circuit serves to move the focus lens and the zoom lens along their optical axes in accordance with a control signal supplied from CPU 111.

The correcting lens 103 is used to correct or reduce image blurring due to vibration or camera shake (hand shake), and is connected with the lens driving block 104.

The lens driving block 104 moves the correcting lens 103 in the yaw and pitch directions of the camera, thereby correcting or reducing camera shake (hand shake) due to hand-held-shooting. The lens driving block 104 has a motor for moving the correcting lens 103 in the yaw and pitch directions of the camera and a motor driver for driving the motor.

The diaphragm/shutter mechanism 105 is provided with a driving circuit (not shown). This driving circuit operates the diaphragm/shutter mechanism 105 in accordance with a control signal sent from CPU 111. The diaphragm/shutter mechanism 105 serves as a diaphragm and a shutter of the digital camera 101.

The diaphragm is a mechanism that adjusts an amount of light to reach CCD 106 and the shutter is a device that adjusts a period of time in which CCD 106 is exposed to light. The period of time (exposure time), during which CCD 106 is exposed to light varies depending on the shutter speed.

The amount of light to reach CCD 106 is determined depending on the effective aperture and the shutter speed.

CCD 106 is scanned by the vertical driver 107, and then RGB (red, green, and blue) light intensities of a subject are subjected to photoelectric conversion every constant periods, whereby an image pickup signal is obtained. The image pickup signal is output from CCD 106 to the unit circuit 109. Timings of operations of the vertical driver 107 and the unit circuit 109 are controlled by CPU 111 through TG 108.

The unit circuit 109 is connected with TG 108, and comprises CDS (Correlated Double Sampling) circuit, AGC (Automatic Gain Control) circuit, and A/D (Analog/Digital) converter, wherein CDS circuit subjects the image pickup signal output from CCD 106 to a correlated double sampling process and holds the sampled image pickup signal, and AGC circuit controls the gain of the sampled image pickup signal, and then A/D converter converts the gain controlled signal into a digital signal. The image pickup signal obtained by CCD 106 is processed by the unit circuit 109 and further supplied to DMA 110. DMA 110 stores the image pickup signal as image data of Bayer pattern in the buffer memory (DRAM 114).

CPU 111 is an one-chip microcomputer, which has functions for implementing AE (Automatic Exposure) process and AF (Automatic Focusing) process, and controls operations of various units within the digital camera 101.

In the digital camera 101 according to the embodiment of the invention, CPU 111 makes an image pickup unit obtain plural pieces (or sheets) of image data of the subject with the optical axis moved relatively to the subject, wherein the image pickup unit consists of components from the image pickup lens 102 to DMA 110, as shown in FIG. 1. Further, CPU 111 executes the following processes on the obtained plural pieces (sheets) of image data: a distance calculation process; Graph cuts; a real-size calculating process; and an object searching process. More particularly, in the distance calculation process, CPU 111 calculates a distance from the image pickup unit to the subject. Further, in Graph cuts, CPU 111 clips the area of a main object of the subject out of the subject image, and calculates the real size of the main object, using the distance from the image pickup unit to the subject and the focal length of the image pickup lens 102. Then, attaching information of the real size, CPU 111 accesses the database 116 of the main objects to perform the object searching process, thereby searching for a sort of the main object.

The key input unit 112 comprises plural operation keys, such as a shutter button, a mode switching key, a cross key, and a set key. The shutter button can be pressed half-way and/or full-way by a user. The key input unit 112 supplies an operation signal to CPU 111 in response to key operation performed on the key input unit 112 by the user.

The memory 113 stores a control program and necessary data, which are used by CPU 111 to control the operations of the various units within the digital camera 101. CPU 111 operates in accordance with the control program.

DRAM 114 is used as a buffer memory for temporarily storing image data obtained by CCD 106, and also used as a working memory of CPU 111.

The blur detecting unit 117 is provided with angular rate sensors such as gyro-sensors (not shown) and serves to detect an amount of camera-shake or an amount of hand-shake of the user. The blur detecting unit 117 is provided with two gyro-sensors (not shown), one for detecting an amount of camera-shake in the yaw direction and the other for detecting an amount of camera-shake in the pitch direction. The amounts detected by the blur detecting unit 117 are supplied to CPU 111.

DMA 118 serves to reads the image data of Bayer pattern from the buffer memory (DRAM) 114 and to supply the same data to the image producing unit 119.

The image producing unit 119 performs a pixel interpolation process, a gamma correction process, and a white balancing process on the image data sent from the DRAM 114 and produces a luminance signal and color difference signals (YUV data). In other word, the image producing unit 119 is a unit for performing an image processing.

DMA 120 serves to store the image data (YUV data) processed by the image producing unit 119 in the buffer memory (DRAM) 114.

MDA 121 serves to supply the displaying unit 122 with the image data (YUV data) stored in the buffer memory (DRAM) 114.

The displaying unit 122 has a color LCD and a driving circuit for driving the color LCD, and displays the image data sent from DMA 121.

DMA 123 serves to output the image data (YUV data) and coded image data stored in the buffer memory (DRAM) 114 to the CODEC unit 124, and to store the image data coded or decoded by the CODEC unit 124 in the buffer memory (DRAM) 114.

The CODEC unit 124 serves to encode or decode image data, for instance, in the format of JPEG and/or MPEG.

DMA 125 serves to read coded image data from the buffer memory (DRAM) 114 and store the same data in the flash memory 126, and vice versa.

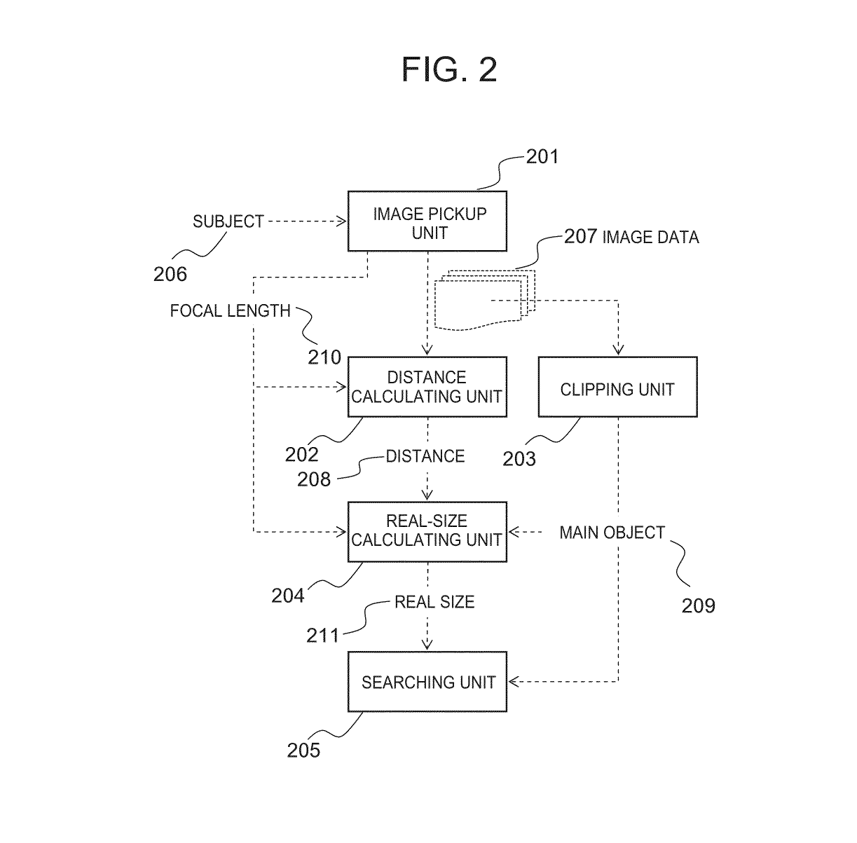

FIG. 2 is a block diagram showing functions of an object searching apparatus realized by the digital camera 101 shown in FIG. 1.

An image pickup unit 201 obtains plural pieces of image data of the subject with the optical axis moved relatively to the subject. For instance, the image pickup unit 201 is provided with a correcting lens, the optical axis of which is moved to correct or reduce the image blur due to camera shake (hand shake). The image pickup unit 201 obtains plural pieces of image data 207 with the optical axis of the correcting lens moved.

A distance calculating unit 202 calculates a distance 208 from the image pickup unit 201 to the subject 206, using the plural image data 207.

A clipping unit 203 clips, for instance, the area of a main object out of a subject image 206 represented by one of the plural pieces of image data 207. Area label values are given to respective pixels of the image data 207 to indicate the main object or the background of the subject. While updating the area label values indicating either the main object or the background, the clipping unit 203 effects a minimizing process of an energy function, for example, using Graph cuts, to evaluate a variation in pixel value between a pixel adjacent to and a pixel falling within the main object-ness or the background-ness, based on said area label values and pixel values of the respective pixels, thereby separating the area of the main object from the area of the background in the image data 207 to clip out the main object 209.

A real-size calculating unit 204 uses the size of the clipped main object 209 on the image data 207, the distance 208 from the image pickup unit 201 to the subject 206, and the focal length 210 of the image pickup unit 201 to calculate the real size 211 of the main object 209.

Attaching information of the real size 211, a searching unit 205 accesses the database 116 of the main objects (Refer to FIG. 1) to search for the sort of the main object 209.

The functions (shown in FIG. 2) of the object searching apparatus are realized by the digital camera 101 shown in FIG. 1. As shown in FIG. 2, plural pieces of image data 207 are obtained by the image pickup unit 201 with its optical axis moved relatively to the subject 206, and the real size 211 of the main object 209 is calculated based on the plural pieces of image data 207, and adding information of the real size of the main object will enhance the accuracy in searching for the sort of the main object 209.

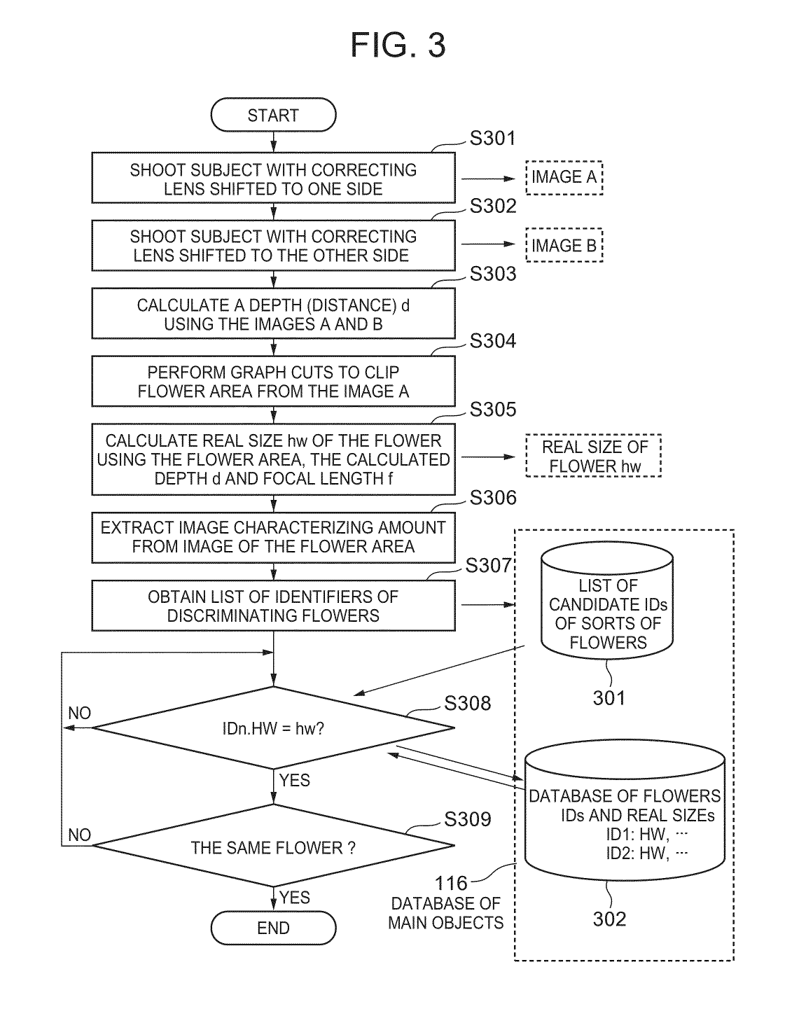

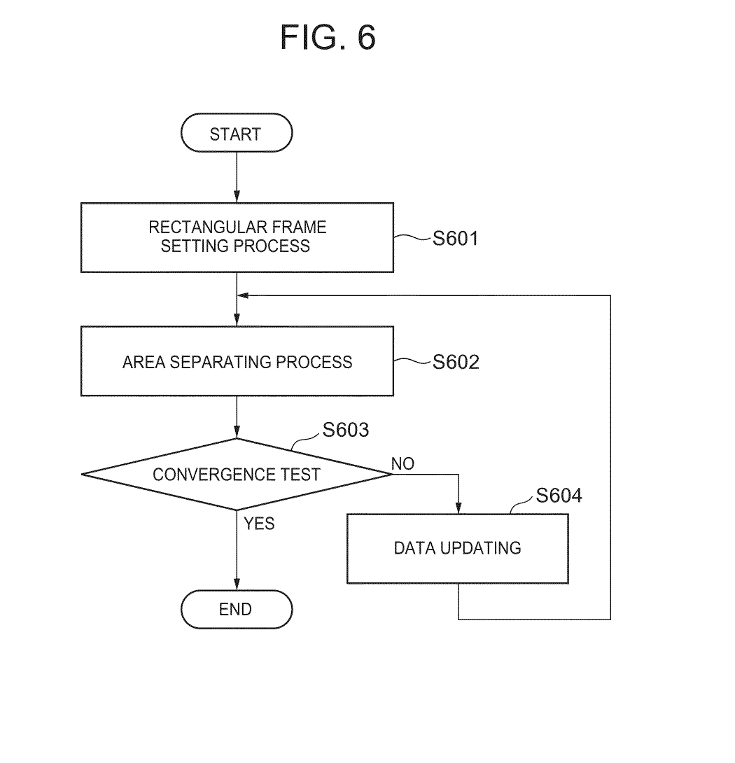

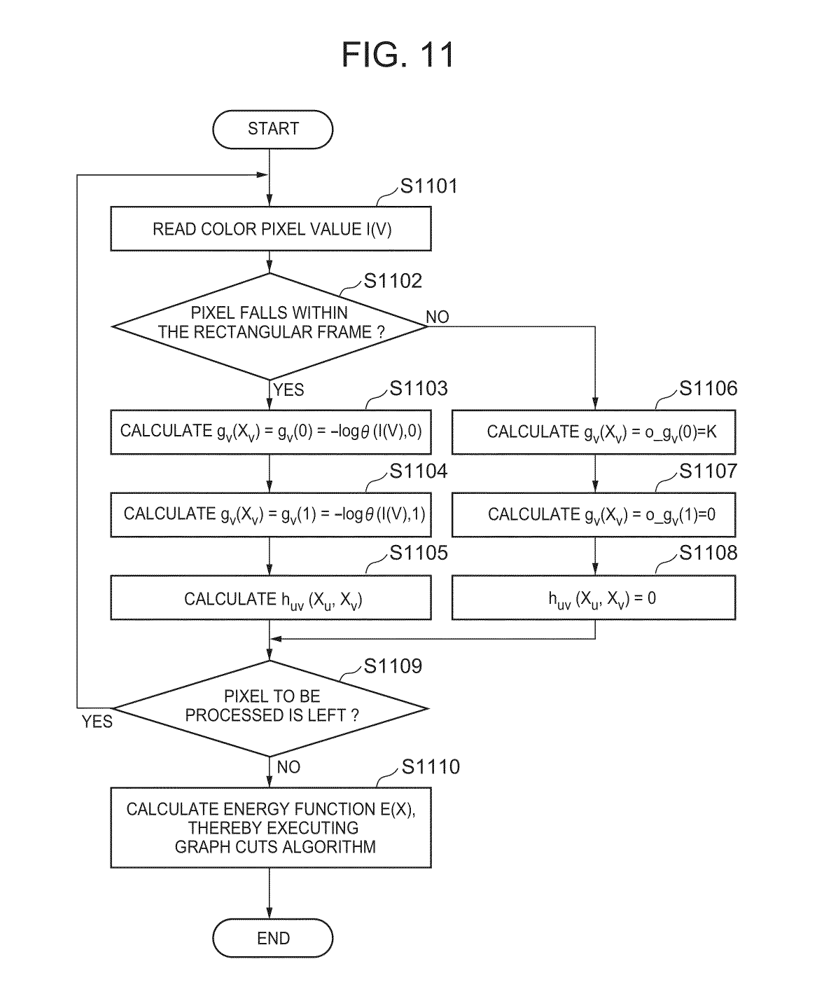

FIG. 3 is a flow chart of the object searching process performed in the present embodiment of the invention. The object searching process is performed by CPU 111 of the digital camera 101 shown in FIG. 1, together with the processes shown in FIG. 6 and FIG. 11. While performing these processes, CPU 111 uses DRAM 114 as the working memory and runs the control program stored in the memory 113.

The subject 206 (Refer to FIG. 2) is shot by the correcting lens 103 of FIG. 1 with the optical axis shifted to one side in the vertical direction, whereby image data 207 (Refer to FIG. 2) is obtained and stored as an image A in DRAM 114 (step S301 in FIG. 3). Similarly, the subject 206 is shot by the correcting lens 103 with the optical axis shifted to the other side in the vertical direction, whereby image data 207 is obtained and stored as an image B in DRAM 114 (step S302 in FIG. 3). The image pickup unit 201 of FIG. 2 performs the processes at steps S301 and S302 in FIG. 3.

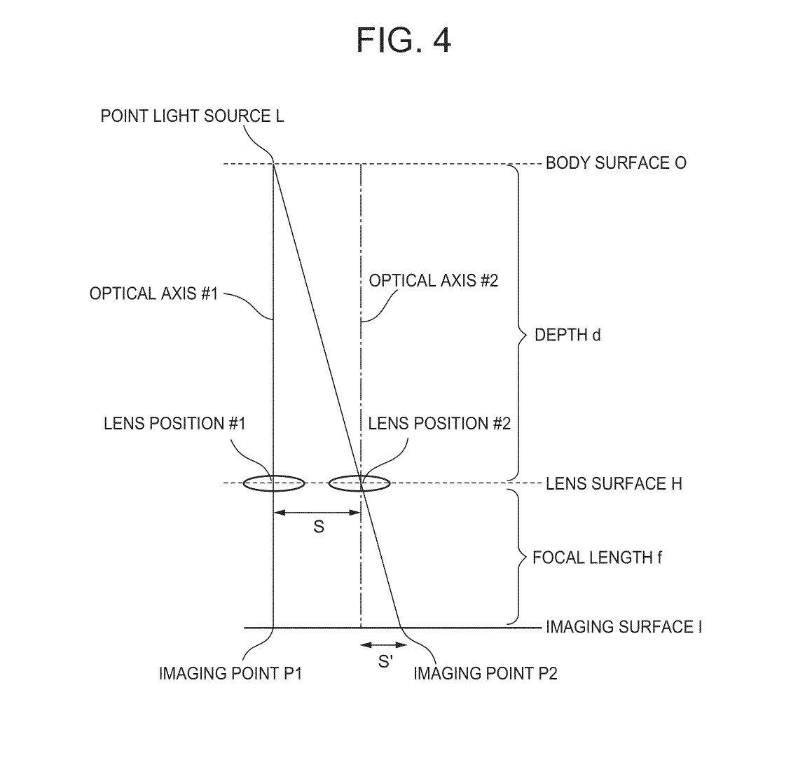

Using the images A and B stored in DRAM 114, CPU 111 calculates a depth (distance) “d” from a lens surface of the image pickup lens 102 of FIG. 1 to the subject (step S303 in FIG. 3). FIG. 4 is a view for explaining a depth calculating process performed in the present embodiment of the invention.

For the sake of simple explanation, a case is considered, where the image pickup lens 102 including the correcting lens 103 is held at a lens position #1 and a point light source L stays on the optical axis #1, wherein the image pickup lens 102 is a virtual lens consisting of plural lenses and the lens position #1 is defined by a position where the lens surface H of such virtual lens intersects the optical axis #1. In this case, an image of the point light source L is focused at an imaging point P1 on an imaging surface I of CCD 106 shown FIG. 1. When the correcting lens 103 is adjusted by the lens driving block 104, the image pickup lens 102 including the correcting lens 103 is shifted or moved by a distance S from the lens position #1 (corresponding to the optical axis #1) to a lens position #2 (corresponding to the optical axis #2), wherein the lens position #2 is a position where the lens surface H of the virtual lens intersects the optical axis #2. As a result, the image of the point light source L is focused at an imaging point P2 on the imaging surface I of CCD 106 shown FIG. 1. In this case, a triangle drawn by connecting the point light source L, the lens position #1 and the lens position #2, and a triangle drawn by connecting the lens position #2, the imaging point P2 and a point where the optical axis #2 intersects the imaging surface I of CCD 106 are similar triangles, and therefore, the following equation will be true:

f:d=S′:S (1)

In the above formula, S denotes the moving distance of the correcting lens 103, and “d” denotes a distance from the lens surface H of the virtual lens to the surface of a body O or the point light source L. The distance “d” is referred to as the “depth” (the distance 208 in FIG. 2), and can be calculated as follows:

d=f×S/S′ (2)

In the above formula, “f” is the focal length 210 (FIG. 2) from the lens surface H of the virtual lens to the imaging surface I of CCD 106, S is the moving distance of the correcting lens 103 from the optical axis #1 to the optical axis #2, and S′ is a distance from the point where the optical axis #2 intersects the imaging surface I of CCD 106 to the imaging point P2.

Since S′ is the distance measured on the imaging surface I of CCD 106 shown in FIG. 1, when S′ is calculated from a pickup image, S′ will be obtained by multiplying a pixel pitch (size per pixel) by the number of pixels (pixel count) on the imaging surface I. That is,

S′=size per pixel×pixel count (3)

For the sake of simple explanation, the above calculating formula has been explained on the assumption that the lens position #1 of the image pickup lens 102 including the correcting lens 103 is on the optical axis #1 passing through the point light source L, but the similar relationship will be true for two arbitrary lens positions.

The distance calculation process performed at step S303 in FIG. 3 based on the principle described above realizes the function of the distance calculating unit 202 of FIG. 2.

Then, Graph cuts is performed to clip the area of the main object 209 (Refer to FIG. 2) out of the image A obtained at step S301 (or the image B obtained at step S302) (step S304). Graph cuts will be described in detail later. The process at step S304 will realize the function of the clipping unit 203 of FIG. 2. Hereinafter, the object searching process will be described on the assumption that the main object 209 is a flower.

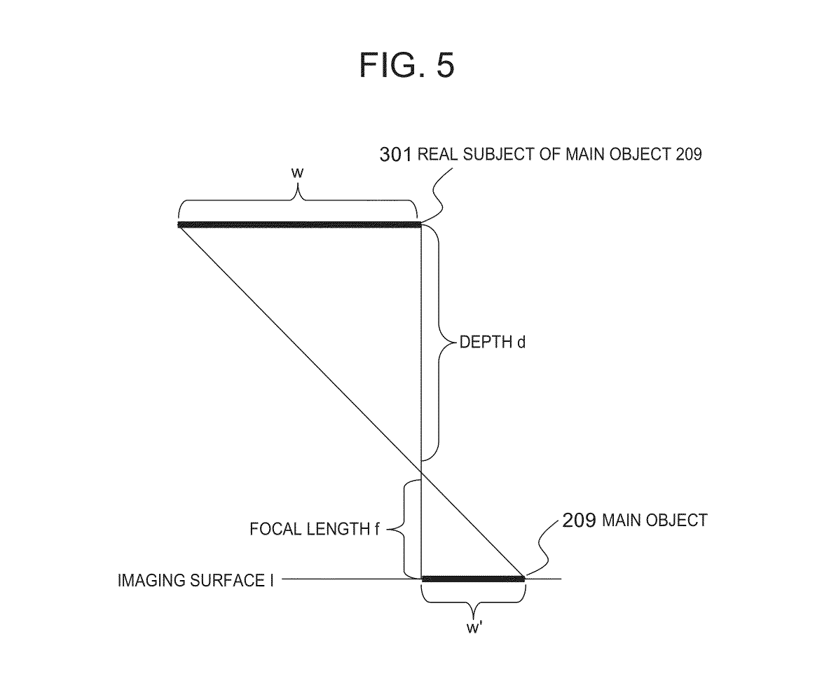

Then, a real size hw of the flower area is calculated using a width of the main object 209 or flower area clipped at step S304, the depth “d” calculated at step S303, and the focal length 210 “f” of the whole lens including correcting lens 103 and the image pickup lens 102 shown in FIG. 1 (step S305). FIG. 5 is a view for explaining the real size calculating process performed in the present embodiment of the invention.

As shown in FIG. 5, the focal length 210 or “f” and the depth “d”, the width “w′” of the main object or the flower area on the imaging surface of CCD 106 (FIG. 1) and the real width “w” of the real main object 209 or the real flower (subject) are in the similar triangles and will have the following relationship:

f:d=w′:w (4)

Therefore, the real width “w” of the real flower will be calculated as follows:

w=w′×d/f (5)

Since “w′” is the distance measured on the imaging surface I of CCD 106 shown in FIG. 1, when “w′” is calculated from a pickup image, “w′” will be obtained by multiplying a pixel pitch (size per pixel) by the number of pixels (flower pixel count) in the area of the main object 209 or the flower area on the imaging surface I. That is,

w′=size per pixel×flower pixel count (6)

The real size calculating process performed at step S305 in FIG. 3 based on the principle described above realizes the function of the real-size calculating unit 204 of FIG. 2. In this case, not only the real width “w” of the flower or the main object 209 but also the real height “h” of the flower are calculated based on a proportional relationship between the width and height of the main object 209. In this way, the real size 211=hw (height and width) of the flower or the main object 209 is calculated.

After the real size 211=hw of the main object 209 or the flower has been calculated, an image characterizing amount is extracted from image data of the flower area or the main object 209 clipped at step S304 in FIG. 3 (step S306 in FIG. 3).

Using the image characterizing amount extracted at step S306, a flower discriminator is composed. The flower discriminator refers to a database of sorts of flowers contained in the database 116 of the main objects shown in FIG. 1. As a result, a list of identifiers (ID) of discriminating the flowers is obtained from the database as a list of candidates of the sorts of flowers (step S307 in FIG. 3).

The database storing the real sizes HW is referred to with respect to every identifier (ID) of the flower in the database 116 of the main object. And it is judged whether the real size HW (IDn, HW) of IDn (n=1, 2, . . . ) coincides with the real size 211=hw of the flower calculated at step S305 within a range of a certain error (step S308 in FIG. 3).

When it is determined that the real size HW of one identifier IDn does not coincide with the real size 211=hw of the flower (NO at step S308), then it is judged again, whether the real size HW of the following identifier IDn coincides with the real size 211=hw of the flower within the range of a certain error.

When it is determined that the real size HW of one identifier IDn coincides with the real size 211=hw of the flower (YES at step S308), then it is judged whether the identifier IDn indicates the same flower as contained in the list of candidates of the sorts of flowers calculated at step S307 in FIG. 3 (step S309 in FIG. 3).

When it is determined that the identifier IDn does not indicate the same flower as contained in the list of candidates of the sorts of flowers (NO at step S309), then it is judged again, whether the following identifier IDn indicates the same flower as contained in the list of candidates of the sorts of flowers.

When it is determined that the identifier IDn indicates the same flower as contained in the list of candidates of the sorts of flowers (YES at step S309), the flower is output as the result of the searching process, and the searching process of flowers finishes.

A series of processes from step S306 to step S309 realize the function of the searching unit 205 of FIG. 2.

In the object searching process shown in FIG. 3, when the real size 211 of the flower or the main object 209 is calculated and the information of the real size 211 of the flower is added or used to search for the sort of a flower, the accuracy in such search will be enhanced. In this case, when the correcting lens 103, which is originally mounted on the digital camera 101 is adjusted for reducing camera shake, it is possible to effectively calculate the real size 211 of the main object 209.

FIG. 6 is a flow chart of Graph cuts at step S304 in FIG. 3. (Graph cuts is performed by CPU 111.)

At first, a rectangular frame setting process is performed (step S601 in FIG. 6). In the rectangular frame setting process, the user displays on the displaying unit 122 (FIG. 1) one image (for example, the image A shown in FIG. 3) represented by one of the plural pieces of image data 207 (FIG. 2) obtained by the image pickup unit 102 to 110 shown in FIG. 1. The user designates a rectangular frame including an area surrounding an object (for instance, a flower in the present embodiment) that he or she wants to recognize on the displayed image, using an input device such as input panel, or sliding his or her finger on the touch panel.

Then, an area separating process (Graph cuts) is executed on the pixels within an image area to separate the area of the main object from the area of the background (step S602 in FIG. 6). The area separating process will be described in detail later.

After the area separating process has finished once, a convergence test is executed (step S603 in FIG. 6). In the convergence test, when one of the following conditions is satisfied, the result of the test will be YES:

(1) the number of repetition is more than a certain level,
(2) a difference in area between the main object and the background is a certain level or less.

When it is determined NO in the convergence test (NO at step S603), a cost function gᵥ(Xᵥ) of the rectangular frame designated by the user is modified in the following manner depending the area separating process previously performed, thereby updating data (step S604 in FIG. 6). This cost function gᵥ(Xᵥ) will be described later. The histogram of the area designated as the main object in the area separating process at step S602 is mixed with a previously prepared histogram θ (c, 0) to be described later with respect to each color pixel value “c”, whereby a new histogram θ (c, 0) representing a new main object-ness is produced. And then a cost function gᵥ(Xᵥ) is calculated based on the new histogram θ (c, 0) (Refer to a mathematical formula (12) to be described later). Similarly, the histogram of the area designated as the background in the area separating process at step S602 is mixed with a previously prepared histogram θ (c, 1) to be described later for example at a constant rate with respect to each color pixel value “c”, whereby a new histogram θ (c, 1) representing a new background-ness is produced. And then the cost function gᵥ(Xᵥ) is calculated based on the new histogram θ (c, 1) (Refer to the mathematical formula (13) to be described later).

When it is determined YES in the convergence test (YES at step S603), the area separating process of FIG. 6 finishes, and the present area of the main object is output as the main object 209 (Refer to FIG. 2), which is the final result of the area separating process.

Hereinafter, the area separating process of step S602 in FIG. 6 will be described in detail.

Now, it is presumed that an area label vector X is given by the following formula:

X=(X₁, . . . , Xᵥ, . . . , X_{V}) (7)

That is, X is the area label vector, where the element Xᵥ denotes an area label of a pixel “v” in an image V. This area label vector X is a binary vector, where, for example, when the pixel “v” is within the area of the main object, X_{V}=0, and when the pixel “v” is within the area of the background, X_{V}=1. That is,

X_{V}=0(pixel vεarea of the main object)

X_{V}=1(pixel vεarea of the background) (8)

The area separating process in the present embodiment of the invention is performed to obtain the area label vector X (the mathematical formula (7)) that minimizes the energy function E(X) given by the following mathematical formula (9):

$$E ( X ) = {\sum }_{v ∈ V} {g}_{v} ( {X}_{v} ) + {\sum }_{( u , v ) ∈ E} {h}_{uv} ( {X}_{u} , {X}_{v} ) \qquad ( 9 )$$

As the result of performing the process of minimizing the energy, the area of the main object or an assembly of pixels “v” having the area label value Xᵥ=0 on the area label vector X is obtained. In the present embodiment of the invention, the area of the main object is the area of flower within the rectangular frame. On the contrary, the assembly of pixels “v” having the area label value Xᵥ=1 on the area label vector X is the area of the background (including outside the rectangular frame).

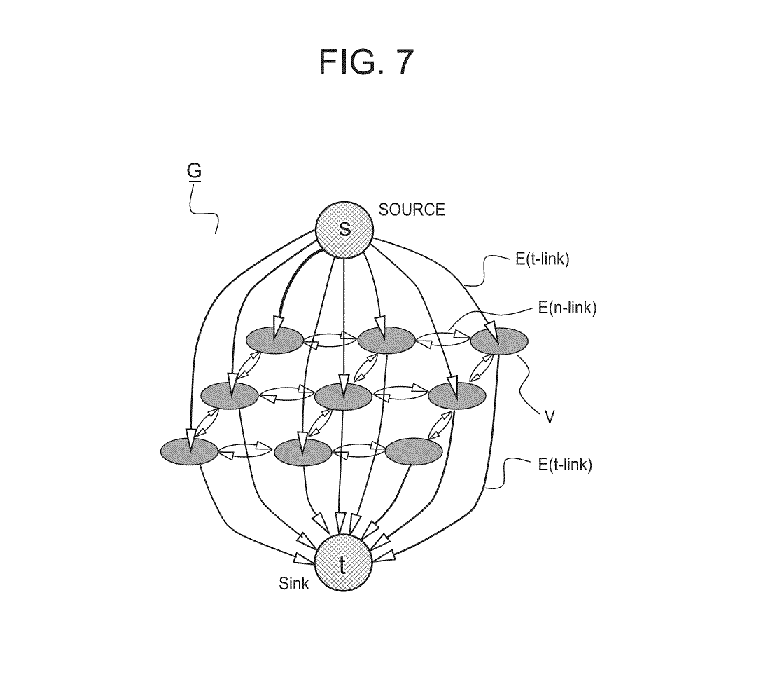

To minimize the energy given by the mathematical formula (9), the following formula and a weighted and directed graph (hereinafter, referred to as the “graph”) as shown in FIG. 7 are defined.

G=(E,V) (10)

In the above formula, V denotes a node, and E denotes an edge. When the graph is applied to the area separation of the image, the pixels of the image correspond to the nodes V, respectively. As the nodes other than the pixels, specific terminals given by the following formula are added, as shown in FIG. 7.

source sεV

sink tεV (11)

The source “s” is considered in relation to the area of the main object and also the sink “t” is considered in relation to the area of the background. The edge E represents a relationship between the notes V. The edge E representing a relationship between the note V and the pixel in the neighborhood is referred to as n-link. The edge E representing a relationship between the pixel and the source “s” (corresponding to the main-object area) or a relationship between the pixel and the sink “t” (corresponding to the background area) is referred to as t-link.

The link of t-link connecting the source “s” with each of the nodes V corresponding to the respective pixels is treated as indicating a relationship representing how much each pixel expresses the main-object area-ness. And a cost value indicating how much each pixel expresses the main-object area-ness is related to the first term of the mathematical formula (9) and defined as follows:

gᵥ(Xᵥ)=gᵥ(0)=−log θ(I(v)0) (12)

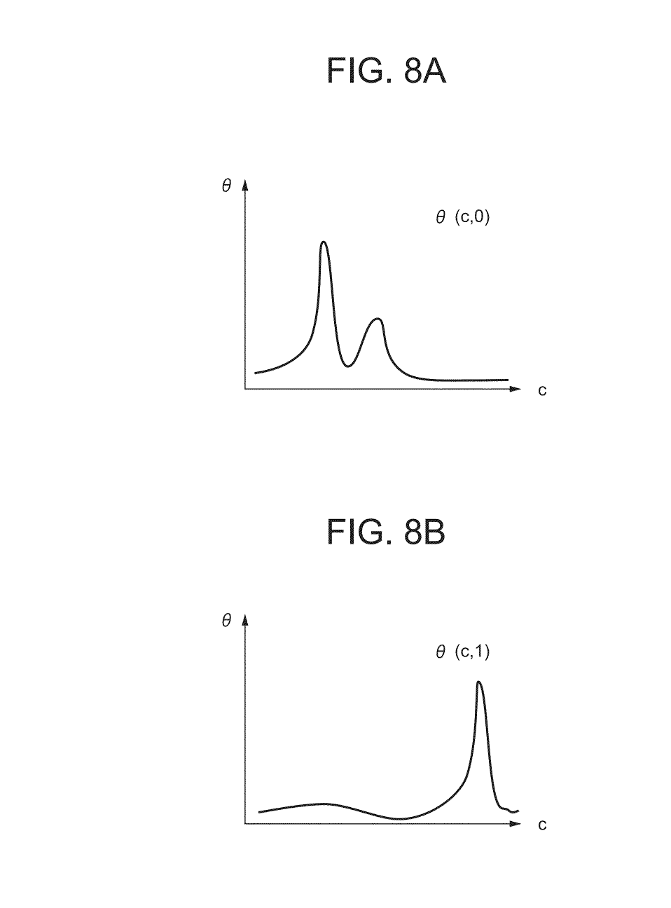

In the above formula, the term θ (c, 0) is function data indicating a histogram (frequency of occurrence) of each color pixel value “c”, which is calculated from plural sheets (about several hundreds of sheets) of the main-object area images prepared for a study supplement, and is previously obtained, for example, as shown in FIG. 8(a). It is presumed that the term θ (c, 0) has been normalized such that the total sum of θ (c, 0) for the whole color pixel values “c” will be 1. I(v) is a color (RGB) pixel value of each pixel “v” in an input image. In practice, sometimes the color (RGB) pixel value is converted into a luminance value, but if not indicated specifically, the term of “color (RGB) pixel value” or “color pixel value” will be used hereinafter for a simple explanation. In the mathematical formula (12), the larger the value of the term θ (I(v), 0), the smaller the cost value. This means that the larger the frequency of occurrence of those among the color pixel values in the previously obtained main-object area, the smaller the cost value obtained by the mathematical formula (12) and the pixel “v” seems to be a pixel in the main-object area. As a result, the value of the energy function E(X) given by the mathematical formula (9) will be pushed down.

The link of t-link connecting the sink “t” with each of the nodes V corresponding to the respective pixels is treated as indicating a relationship representing how much each pixel expresses the background area-ness. And a cost value indicating how much each pixel expresses the background area-ness is related to the first term of the mathematical formula (9) and defined as follows:

gᵥ(Xᵥ)=gᵥ(1)=−log θ(I(v),1) (13)

In the above formula, the term θ (c, 1) is a function data indicating a histogram (frequency of occurrence) of each color pixel value “c”, which is calculated from plural sheets (about several hundreds of sheets) of the background area images prepared for a study supplement, and is previously obtained, for example, as shown in FIG. 8(b). It is presumed that the term θ (c, 1) has been normalized such that the total sum of θ (c, 1) for the whole color pixel values “c” will be 1. Similarly in the mathematical formula (12), I(v) is a color (RGB) pixel value of each pixel “v” in an input image. In the mathematical formula (13), the larger the term θ (I(v), 1), the smaller the cost value. This means that the larger the frequency of occurrence of those in the color pixel values in the previously obtained background area, the smaller the cost value obtained by the mathematical formula (13) and the pixel “v” seems to be a pixel in the background area. As a result, the value of the energy function E (X) given by the mathematical formula (9) will be pushed down.

Then, a cost value of the link of n-link representing a relationship between the node V corresponding to the pixel and the peripheral pixel is defined in relation to the second term of the mathematical formula (9), as follows:

$${h}_{uv} ( {X}_{u} , {X}_{v} ) = \{ \begin{matrix}0 & ( {X}_{u} = {X}_{v} ) \\ \frac{{λe}^{- κ {\{ I ( u ) - I ( v ) \}}^{2}}}{dist ( u , v )} & ( {X}_{u} \neq {X}_{v} )\end{matrix} \qquad ( 14 )$$

In the above formula, dist(u, v) denotes Euclidean distance between the pixel “v” and the peripheral pixel “u”, and “k” denotes a predetermined coefficient. I(u) and I(v) are color (RGB) values of pixels “u” and “v”, respectively. In practice, sometimes the color (RGB) pixel values can be converted into the luminance values, as described above. When an area label value Xᵥ of the pixel “v” and an area label value Xᵤ of the peripheral pixel “u” are selected such that both values will be equivalent to each other (Xᵤ=Xᵥ), the cost value given by the mathematical formula (14) will be 0, and they will have no influence on the calculation of the energy E(X).

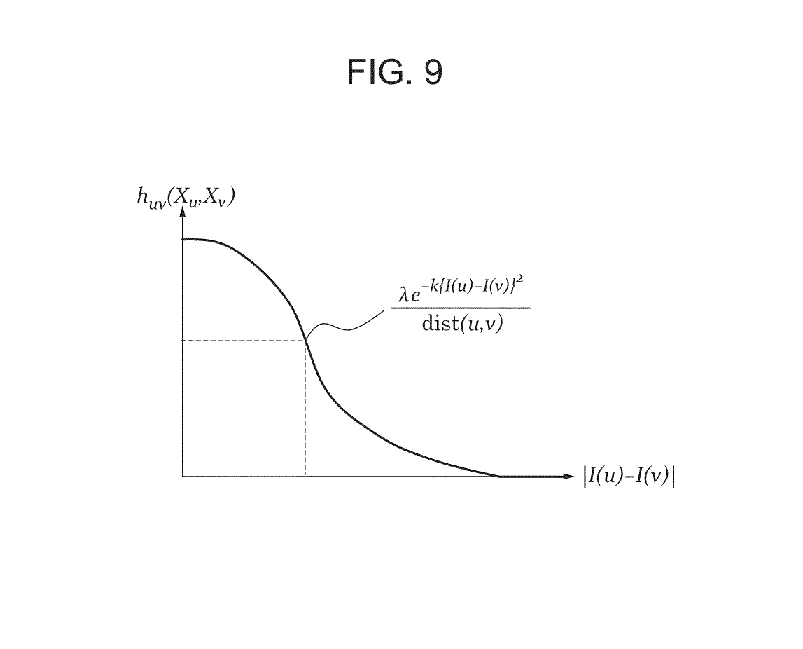

Meanwhile, when the area label value Xᵥ of the pixel “v” and the area label value Xᵤ of the peripheral pixel “u” are selected such that both values will be not equivalent to each other (Xᵤ≠Xᵥ), the cost value given by the mathematical formula (14) will have a functional characteristic, for example, as shown in FIG. 9. That is, when the area label value Xᵥ of the pixel “v” and the area label value Xᵤ of the peripheral pixel “u” are not equivalent, and the difference I(u)−I(v) in color pixel value (luminance value) between the pixel “v” and the peripheral pixel “u” is small, the cost value given by the mathematical formula (14) will be large. In this case, the value of the energy function E(X) of the mathematical formula (9) will be pushed up. In other words, when the difference in color pixel value (luminance value) between the pixels in the neighborhood is small, the area label values of these pixels are not selected such that they will be different. That is, in this case, the area label values of the pixels in the neighborhood will be close to each other as possible, and the main-object area and the background area are controlled not to change as possible. Meanwhile, when the area label value Xᵥ of the pixel “v” and the area label value Xᵤ of the peripheral pixel “u” are different from each other and the difference I(u)−I(v) in color pixel value (luminance value) between the pixel “v” and the peripheral pixel “u” is large, the cost value given by the mathematical formula (14) will be small. In this case, the value of the energy function E(X) of the mathematical formula (9) will be pushed down. In other words, when the difference in color pixel value (luminance value) between the pixels in the neighborhood is large, it means that this seems to be a boundary between the main object area and the background area and the area label value of the pixel “v” and the area label value of the peripheral pixel “u” are controlled in the opposite direction.

Using the definition described above, the mathematical formula (12) is operated with respect to all the pixels “v” in the input image to calculate the cost value (the main-object area-ness) of the links of t-link for connecting the source “s” with the pixels “v” in the input image. Also, the mathematical formula (13) is operated with respect to all the pixels “v” in the input image to calculate the cost value (the background area-ness) of the links of t-link for connecting the sink “t” with the pixels “v”. Further, the mathematical formula (14) is operated with respect to all the pixels “v” in the input image to calculate the cost value (the boundary-ness) of 8 links of n-link for connecting the pixel “v” with its peripheral pixels, for example, with 8 pixels respectively in 8 directions.

In theory, the energy function E(X) given by the mathematical formula (9) is calculated with the calculation results of the mathematical formulas (12), (13) and (14) selected, every combination of all the area label values 0 or 1 of the area label vector X (the mathematical formula (7)). When the area label vector X is selected, which minimizes the value of the energy function E(X) with respect to all the combinations of the area label values, the main object area can be obtained as an assembly of the pixels “v” whose area label value is 0 (Xᵥ=0) on the area label vector X.

But in practice, the number of combinations of all the area label values 0 or 1 in the area label vector X is the number of pixels-th power of 2, and therefore it is almost impossible to calculate the minimizing process of the energy function E(X) within a practical time.

Therefore, in Graph cuts, the following algorithm is effected to calculate the minimizing process of the energy function E(X) within the practical time.

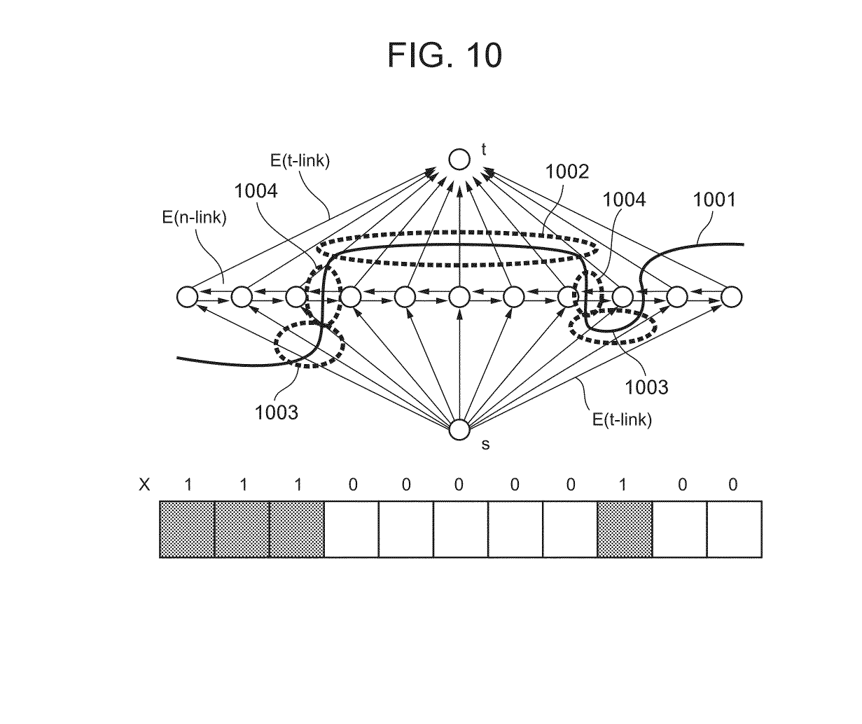

FIG. 10 is a view schematically showing a relationship between a graph, the area label vector X and Graph cuts, wherein the graph includes the links of t-link defined by the mathematical formulas (12) and (13), and the links of n-link defined by the mathematical formula (14). In FIG. 10, the pixels “v” are shown one-dimensionally for easy understanding.

In the calculation of the first term of the energy function E(X) of the mathematical formula (9), at the pixels in the main object area, whose area label value is to be 0 in the area label vector X, the value of the mathematical formula (12) will be smaller when said pixels are possible to be in the main object area, and accordingly the cost value of the mathematical formula (12) will be smaller than the mathematical formulas (13). Therefore, in the case that at a pixel, the link of t-link is selected at the side of the source “s” and the link of t-link is cut at the side of the sink “t” (in the case of 1002 in FIG. 10), and the mathematical formula (12) is operated to calculate the first term of the mathematical formula (9) of E (X), if the calculation result will be small, then a value of 0 will be selected as the area label value of said pixel. And the state of Graph cuts will be employed. If the calculation result will not be small, then the state of Graph cuts will not be employed, and other link will be searched for and other Graph cuts will be tried again.

On the contrary, at the pixels in the background area, whose area label value is to be 1 in the area label vector X, the value of the mathematical formula (13) will be smaller when said pixels are possible to be in the background area, and accordingly the cost value of said formula (13) will be smaller than the mathematical formula (12). Therefore, in the case that at a pixel, the link of t-link is selected at the side of the sink “t”, and the link of t-link is cut at the side of the source “s” (the case of 1003 in FIG. 10), and the mathematical formula (13) is operated to calculate the first term of the mathematical formula (9) of E(X), if the calculation result will be small, then a value of 1 will be selected as the area label value of said pixel. And the state of Graph cuts will be employed. If the calculation result will not be small, then the state of Graph cuts will not be employed, and other link will be searched for and Graph cuts will be tried again.

Meanwhile, the cost value of the mathematical formula (14) will be 0 at the pixels in the main object area or the background area, the area label values of which pixels continuously take 0 or 1 in the area label vector X in the area separating process (Graph cuts) relating to calculation of the first term of the energy function E (X) of the mathematical formula (9). Therefore, the calculation result of the mathematical formula (14) has no effect on calculation of the cost value of the second term of the energy function E (X). Also, the link of n-link for connecting the above pixels is not cut and maintained between the pixels so as to allow the mathematical formula (14) to output the cost value of 0.

But in the case where the area label value should change from 0 to 1 or from 1 to 0 between the pixels in the neighborhood in the area separating process (Graph cuts) relating to calculation of the first term of the energy function E(X) of the mathematical formula (9), when a difference in color pixel value between said pixels is small, the cost value of the mathematical formula (14) will be large. As a result, the value of the energy function E(X) of the mathematical formula (9) will be pushed up. This case corresponds to a case where judgment of the area label value happen to reverse based on the value of the first term in the same area. Therefore, in this case, the value of the energy function E(X) will be large, resulting in not selecting such reverse of the area label value. Further, in this case, the links of n-link for connecting the above pixels are not cut and maintained between the pixels to allow the calculation result of the mathematical formula (14) to maintain the above result.

On the contrary, in the case where the area label value should change from 0 to 1 or from 1 to 0 between the pixels in the neighborhood in the area separating process (Graph cuts) relating to calculation of the first term of the energy function E(X) of the mathematical formula (9), when the difference in color pixel value between said pixels is large, the cost value of the mathematical formula (14) will be small. As a result, the value of the energy function E(X) of the mathematical formula (9) will be pushed down. In this case, it means that a portion of these pixels seems to be a boundary between the main object area and the background area. Therefore, in this case, the area label values are made different between the pixels and adjusted to direct so as to form the boundary between the main object area and the background area. Further, the links of n-link for connecting these pixels in the neighborhood are cut and the cost value of the second term of the mathematical formula (9) is set to 0 (the case of 1004 in FIG. 10), thereby keeping the boundary in a steady state, formed between the main object area and the background area.

The above described judgment controlling process is successively performed with respect to the links originated from the node of the source “s” and reaching the nodes of pixels, whereby Graph cuts is executed as shown at 1001 in FIG. 10 and the minimizing process of the energy function E(X) can be calculated within the practical time. A specific method of calculating the minimizing process is proposed by Y. Boykov and G. Funka-Lea: “Interactive Graph Cuts for Optimal Boundary & Region Segmentation of Objects in N-D Images”, Proceedings of “Internation Conference on Computer Vision”, Vancouver, Canada, vol. I, p. 105-112, July 2001. This method can be employed to calculate the minimizing process of the energy function E (X) in the present embodiment of the invention.

If any links t-link are left for respective pixels at the side of the source “s”, the area label value of 0 is given to these pixels, that is, a label representing that a pixel is in the main-object area is given to these pixels. On the contrary, if any links t-link are left for respective pixels at the side of the sink “t”, the area label value of 1 is given to these pixels, that is, a label representing that a pixel is in the background area is given to these pixels. Finally, the main object area is obtained as an assembly of pixels having the area label value of 0.

FIG. 11 is a flowchart of the area separating process at step S602 in the flow chart of FIG. 6, wherein the area separating process is performed by CPU 111 on the basis of the operational principle described above.

A color pixel value I(V) is read from one sheet of image data 207 (Refer to FIG. 2) one by one (step S1101 in FIG. 11).

It is judged whether the pixel read from the image data 207 (at step S1101) falls within a rectangular frame designated by the user (step S1102).

When it is determined YES at step S1102, the mathematical formula (12) is operated to calculate the cost value representing the main-object area-ness (step S1103), and the mathematical formula (13) is operated to calculate the cost value representing the background area-ness (step S1104). Further, the mathematical formula (14) is operated to calculate the cost value representing the boundary-ness (step S1105). The initial value of the term θ (c, 0) is calculated from plural sheets (about several hundreds of sheets) of the main-object area images prepared for the study supplement. Similarly, the initial value of the term θ (c, 1) is calculated from plural sheets (about several hundreds of sheets) of the background area images prepared for the study supplement.

Meanwhile, in the case where it is determined NO at step S1102, since the main object area is not found outside the rectangular frame, the cost value gᵥ(Xᵥ) representing the main-object area-ness is set to a constant value K given by the following formula:

gᵥ(Xᵥ)=o_{—}gᵥ(0)=K (15)

in such away that it is not determined that the pixel read from the image data 207 falls into the main-object area. In the above formula, the constant value K is set to a value larger than the total sum of smoothing terms of arbitrary pixels, as shown by the following formula (step S1106):

$$K = 1 + {max}_{u ∈ V} {\sum }_{v \text{:} \{ u , v \} ∈ E} {h}_{uv} ( {X}_{u} , {X}_{v} ) \qquad ( 16 )$$

Further, the cost value gᵥ(Xᵥ) representing the background area-ness is set to 0, as given by the following formula (step S1107):

gᵥ(Xᵥ)=o_{—}gᵥ(1)=0 (17)

in such a way that it is sure to be determined that the pixel falling outside the rectangular frame falls within the background area.

Since the area surrounding the rectangular frame is the background area, the value of hᵤᵥ(Xᵤ, Xᵥ) is set to 0 (step S1108).

After the above processes have been performed, it is judged whether any pixel to be processed is still left in the image (step S1109).

When it is determined that some pixels to be processed are still left in the image (YES at step S1109), CPU 111 returns to step S1101 and repeatedly performs the above processes.

When it is determined that no pixel to be processed is left in the image (NO at step S1109), the cost values calculated with respect to all the pixels in the image are used to calculate the energy function E (X) given by the mathematical formula (9), thereby executing Graph cuts algorithm to separate the main object area 209 (Refer to FIG. 2) from the background area (step S1110).

As described above, in the present embodiment of the invention, specific pixel values cₘ of the same color as the main object 209 such as a flower and the like are suppressed not to renew the histogram of the background, whereby no area separating operation is performed on the basis of the wrong histogram in the following area separating process. As a result, a rate of recognizing in error the background area as the main object area is reduced and accuracy in separating the areas can be enhanced.

In the above description, the case where the main object 209 (FIG. 2) is a flower has been described, the main object is not limited to the flower but various objects other than the flowers can be employed.

What is claimed is:

1. An object searching apparatus for searching through a database of objects, comprising:
an image pickup unit for obtaining plural pieces of image data with an optical axis moved relatively to a subject to be shot;
a distance calculating unit for calculating a distance from the image pickup unit to the subject based on the plural pieces of image data obtained by the image pickup unit;
a clipping unit for clipping a main object of the subject from the image data, wherein the subject at least consists of the main object and a background;
a real-size calculating unit for calculating a real size of the main object of the subject, using a size of the clipped main object on the image data, the distance calculated by the distance calculating unit and a focal length of the image pickup unit; and
a searching unit for accessing the database of objects to search for a sort of the main object of the subject, using the real size of the main object calculated by the real-size calculating unit.

2. The object searching apparatus according to claim 1, wherein the image pickup unit comprises a correcting lens, whose optical axis is moved to compensate for hand shake, and obtains plural pieces of image data with the optical axis of the correcting lens being moved.

3. The object searching apparatus according to claim 1, wherein the clipping unit updates area label values, wherein the area label values are given to respective pixels of the image data, and each indicate either the main object or the background, and minimizes an energy function, which evaluates a difference in pixel value between pixels adjacent to either the main object-ness or the background-ness, based on the area label values and pixel values of the respective pixels of the image data, thereby separating the image data into the main object area and the background area to clip the main object of the subject from the image data.

4. The object searching apparatus according to claim 3, wherein the clipping unit uses Graph cuts to minimize the energy function.

5. A method of searching for an object, used in an object searching apparatus for searching through a database of objects, wherein the apparatus has an image pickup unit for obtaining plural pieces of image data with an optical axis moved relatively to a subject to be shot, the method comprising:
a distance calculating step of calculating a distance from the image pickup unit to the subject based on the plural pieces of image data obtained by the image pickup unit;
a clipping step of clipping a main object of the subject from the image data;
a real-size calculating step of calculating a real size of the main object of the subject, using a size of the clipped main object on the image data, the distance calculated at the distance calculating step and a focal length of the image pickup unit; and
a searching step of accessing the database of objects to search for a sort of the main object of the subject, using the real size of the main object calculated at the real-size calculating step.

6. A non-transitory computer-readable recording medium having stored thereon a program for controlling operation of an object searching apparatus for searching through a database of objects, wherein the object searching apparatus comprises a computer and an image pickup unit for obtaining plural pieces of image data with an optical axis moved relatively to a subject to be shot, and wherein the program, when read and executed on the computer, makes the computer function as:
a distance calculating unit for calculating a distance from the image pickup unit to the subject based on the plural pieces of image data obtained by the image pickup unit;
a clipping unit for clipping a main object of the subject from the image data;
a real-size calculating unit for calculating a real size of the main object of the subject, using a size of the clipped main object on the image data, the distance calculated by the distance calculating unit and a focal length of the image pickup unit; and
a searching unit for accessing the database of objects to search for a sort of the main object of the subject, using the real size of the main object calculated by the real-size calculating unit.
